(19) United States
(12) Patent Application Publication
(10) Pub. No.: US 2022/0144352 A1
(43) Pub. Date: May 12, 2022

(54) COMBINATION VEHICLE PANEL

(71) Applicant: Century Plastics, LLC d/b/a CIE USA, Shelby Township, MI (US)

(72) Inventor: Jeffery M. Nelson, Imlay City, MI (US)

(73) Assignee: Century Plastics, LLC d/b/a CIE USA, Shelby Township, MI (US)

(21) Appl. No.: 17/520,712

(22) Filed: Nov. 7, 2021

Related U.S. Application Data
(60) Provisional application No. 63/110,346, filed on Nov. 6, 2020.

(51) Int. Cl. B62D 33/027; A47B 5/06; A47B 5/04; B60R 9/06

(52) U.S. Cl. CPC B62D 33/0273; B60R 9/06; A47B 5/04; A47B 5/06

(57) ABSTRACT

A combination panel assembly includes a vehicle panel and a leg system. The vehicle panel includes a first panel side defining a vehicle appearance surface, and an opposing second panel side. The leg system is attached to the second panel side and includes a plurality of legs movable between a stowed position and a deployed position. The combination panel assembly is movable between a vehicle position and a table position. In the vehicle position and with the plurality of legs in the stowed position, the vehicle panel encloses a compartment opening of a vehicle compartment of a vehicle. In the table position and with the plurality of legs is in the deployed position, the combination panel assembly is fully detached from the vehicle and operable as a freestanding table including a table surface defined by the vehicle appearance surface and supported at a table height by the leg system.

### CROSS-REFERENCE TO RELATED APPLICATION

This application claims priority to and the benefit of U.S. Provisional Application No. 63/110,346, filed Nov. 6, 2020, the contents of which are hereby incorporated by reference in their entirety.

### TECHNICAL FIELD

The present disclosure pertains to combination panel assembly including a vehicle panel and a plurality of table legs, and in particular, where the combination panel assembly is operable as an enclosure panel and as a freestanding table.

### BACKGROUND

Activities and events such as tailgating, picnicking, camping, sporting events, swap meets, flea markets, craft shows, etc. often include the use of a table for food preparation and service, as a work surface, for item display or storage, etc. Participants in these activities and events may be transported in a vehicle which is also used to transport a table for use during the activity or event, which may be, for example, a folding table which can be collapsed from an upright position to a folded position for storage when not in use. During transport, the folding table consumes cargo space in the vehicle which could be used for storing or transporting other items or which could be used for passenger space. The capability to transport the folding table in the vehicle may be limited by the size of the cargo space in the vehicle and/or the availability of cargo space after other essential cargo and/or passengers are loaded to the vehicle.

Vehicle-mounted accessory tables which can be attached to a vehicle, such as tailgate-mounted and trailer hitch-mounted tables, are known. During transport, this type of vehicle-mounted accessory table and attaching hardware is typically stored in the vehicle, consuming cargo space which is then not available for storing other items or passengers. The accessory table, when mounted to the vehicle in an installed position, can block access to the truck bed and/or cargo area and/or interfere with use of the area of the vehicle to which the accessory table is attached. Accessory tables which are extendable from a portion of a vehicle, for example, tables which are extendable from a truck tailgate or cargo floor, are known. When in an extended position, this configuration of table can interfere with access to the truck bed and/or vehicle area from which the table is being extended. Because both the vehicle-mounted and extending accessory tables are necessarily attached to the vehicle during use of the table, the table can only be positioned in an area immediately adjacent to the vehicle to which the table is attached, and only in an area accessible by the vehicle itself, e.g., an area where the vehicle can be parked. Further, with the table attached and/or installed to the vehicle, the vehicle must remain in a stationary position until the table is detached from and/or restowed to the vehicle, such that the vehicle and the table cannot be used independently of each other.

Vehicles, such as automobiles, trucks, vans, sport utility vehicles (SUV), boats, include enclosure panels which are used to enclose an opening or compartment in the vehicle, such that the enclosure panels are typically not removed from the vehicle during use. Examples of such enclosure panels include floor panels positioned in a floor, trunk, storage compartment, cargo space, passenger space (to enclose a retractable seat, for example) or deck (of a boat, for example) of a vehicle, where the enclosure panel may be configured as a load bearing panel to withstand a force or load imposed on the vehicle panel without failing and/or deflecting more than a predetermined amount. Typically, the enclosure panel in its installed position in the vehicle includes a vehicle appearance surface visible to the vehicle user. The enclosure panel is typically movable relative to the vehicle structure, for example, such that the enclosure panel can be opened to access a compartment or vehicle area enclosed by the enclosure panel.

### SUMMARY

A combination vehicle panel, also referred to herein as a combination panel assembly (CPA), is described herein. The combination panel assembly includes a vehicle panel and a leg system, where the leg system is deployable in a stowed position and in a deployed position. The vehicle panel can be referred to herein as an enclosure panel, for enclosing an opening in a vehicle structure. The vehicle panel includes a first panel side defining a vehicle appearance surface, and an opposing second panel side. The leg system is attached to the second panel side and includes a plurality of legs movable between a stowed position and a deployed position. The combination panel assembly is movable between a vehicle position and a table position. In the vehicle position and with the plurality of legs in the stowed position, the vehicle panel encloses a compartment opening of a vehicle compartment of a vehicle, such that in the vehicle position, the combination panel assembly is a component of the vehicle. In the table position and with the plurality of legs is in the deployed position, the combination panel assembly is fully detached from the vehicle and operable as a freestanding table including a table surface defined by the vehicle appearance surface and supported at a table height by the leg system. As such, the combination panel assembly is advantaged as being a dual purposed assembly, being operable as both a closure panel enclosing a vehicle compartment, and as a freestanding table. The leg system of the combination panel assembly, when in a stowed position, is fully contained in the vehicle compartment being enclosed by the vehicle panel of the combination panel assembly, providing the advantage of transporting a table in the vehicle without consuming any of the interior cargo space of the vehicle. Further, the combination panel assembly provides advantages of convenience and cost savings to the vehicle user, by having a deployable table in the vehicle at all times, such that the table is available for use to the vehicle user without any advance planning and without having to load a separate table into the vehicle from another location, or incur the cost of acquiring a separate table. Additionally, as compared to known vehicle-mounted accessory tables, such as hitch-mounted or tailgate-mounted accessory tables which can only be used when the vehicle is in a parked condition, which can only be located where the vehicle is parked, and which must be stored when not in use, consuming cargo space of the vehicle, the combination panel assembly disclosed here provides numerous advantages including the capability of capability to fully detach the combination panel assembly from the vehicle and to deploy the table as a freestanding table in any location to which the combination panel assembly can be transported away from the vehicle, such that when the combination panel assembly is in use as a table, the vehicle and the table are independent and detached from each other, such that each can be used independent of the other. Further, the combination panel assembly is lightweight, such that it can be transported manually, and in an illustrative example, has a leg system which is adjustable to various leg lengths, to advantageously provide a table having various table heights adjustable for different use conditions, described further herein.

In one example, the combination vehicle panel, also referred to herein as a combination panel assembly, includes a multilayer panel and a leg system including a plurality of legs, the plurality of legs operable as table legs in the deployed position. The leg system is attached to the vehicle panel and configured such that the legs are selectively moveable relative to the table, between a stowed position and a deployed position is described herein. In an illustrative example, the vehicle panel and the leg system comprise a vehicle panel assembly configured to enclose an opening to an interior compartment in a vehicle, such that in a vehicle position, e.g., when installed to a vehicle to enclose a vehicle compartment and/or vehicle opening, an appearance outer layer of the vehicle panel defines an appearance surface of the vehicle, and the legs are in a stowed position such that the legs are contained within the interior compartment of the vehicle and/or recessed into or otherwise retained to the multilayer panel. The combination panel assembly is removable from the vehicle to a table position, e.g., can be fully detached from the vehicle such that the combination panel assembly can be moved to a location which is distanced from the vehicle location, also referred to herein as a table position, and such that when the legs of the combination panel assembly are deployed from a stored to a deployed position, the combination panel assembly forms a table which is freestanding from the vehicle. In one example, the vehicle panel is a multilayer panel including a core member and an appearance layer attached to the core member. In one example, the vehicle panel is a load bearing panel, such as a floor panel configured to enclose an interior compartment located in a vehicle floor, and to withstand a load applied to the vehicle panel with a limited amount of deflection.

In an illustrative example, the vehicle panel has opposing appearance and attachment outer layers. The appearance outer layer can be made of a textile material, a carpeting material, a protective polymeric coating such as a thermosetting polyurethane-based coating or a polyvinyl-based material, a thermoset polyurea coating, or a laminate structure which can include a wood veneer. The appearance outer layer, in one example, can include one or more decorative elements including, by way of non-limiting example, a decal, embossment, etching, etc. which is applied to the appearance layer. By way of example, the decorative element can be in the form and/or shape of a pattern, image, logo, etc. applied to the appearance layer. The table legs are attached to the attachment outer layer of the vehicle panel and are pivotable, e.g., foldable, between a stowed position and a deployed position. In one example, the table legs are telescoping, such that the leg length is adjustable between a compacted length and a fully extended length.

With the legs in the stowed position, the combination panel assembly is configured to enclose an opening to an interior compartment by positioning the vehicle panel in the opening, in a vehicle installed position, such that the appearance outer layer is outwardly facing in the opening and the attachment outer layer faces inwardly to the compartment. The vehicle installed position can also be referred to herein as a vehicle position. In a table position, the combination panel assembly is removed from the opening and from the vehicle to a position exterior of the vehicle, such that, in the table position, the combination panel assembly is fully detached from and distanced from the vehicle. In the table position, and with the legs deployed from the stowed position to the deployed position, the combination panel assembly is operable as a freestanding table comprising the vehicle panel and the leg system including the plurality of legs.

In one example, the multilayer panel includes a compression molded core member interposed between the appearance outer layer forming a first side of the vehicle panel, and the attachment outer layer forming a second side of the vehicle panel, where the core layer is configured as a load bearing layer such that the multilayer panel can withstand a minimum knee loading requirement. In one example, the vehicle panel is a load bearing panel having a load capacity such that deflection of the vehicle panel in the direction a minimum knee load (KL) of at least 250 pounds is applied as a point load to a central portion of the vehicle panel is applied does not exceed 25 mm during loading, and/or such that the permanent deflection of the vehicle panel after loading to 250 pounds knee load does not exceed 10 mm. In one example, the vehicle panel is a vehicle floor panel configured to withstand bending and deflection forces and loads imposed by items which may be place on the floor panel, which may include vehicle users standing, sitting or kneeling on the floor panel, or items placed on the exposed surface of the floor panel, which can include personal items of the vehicle user such as luggage, sporting goods, groceries, furniture, etc., and can further include industrial items such as tools and equipment, wherein in an illustrative example, the vehicle panel has a distributed load capacity of 400 pounds or greater.

In an illustrative example, the core layer can be made of a cellular material which provides the load bearing strength using a lightweight material, such that the combination panel assembly including the lightweight core member which is readily transportable as a portable table to a location which may be distanced from the vehicle. In an illustrative example, the vehicle panel is a panel configured as disclosed in U.S. patent application Ser. No. 15/943026, published as US Publication No. 2018/0290418 A1, which is incorporated herein by reference. In one example, the combination vehicle panel, including the vehicle panel and leg assemblies, has a total weight of less than 20 pounds, such that the combination vehicle panel is easily removed from the vehicle and manually transported a distance from the vehicle. The combination vehicle panel has a total weight of less than 15 pounds in one example. In a preferred example, the combination vehicle panel has a total weight of less than 12 pounds.

In an illustrative example, the combination vehicle panel is configured as a floor panel to enclose an opening in a vehicle, such as an opening in a load floor or wall of a cargo area of a vehicle. At least one interior compartment may be accessible through the opening, such that with the floor panel positioned in the opening, the floor panel encloses the interior compartment away from an exterior compartment of the vehicle, where the exterior compartment can be, for example, the cargo area and/or passenger area of the vehicle.

The panel can include one or more trim elements attached thereto, including, for example, a closure trim element, such as a bezel element, can be included to enclose and/or encapsulate a perimeter edge of the vehicle panel, to provide a decorative and/or functional table edge. In one example, a sealant layer can be applied to the appearance layer, and a decorative element such as a decal, painted element, etc. can be positioned between the appearance layer and sealant layer. The panel assembly can include a handle for removing the combination panel assembly from the vehicle and/or for conveniently carrying the combination panel assembly to a location distant from the vehicle.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

FIG. 1 is a schematic perspective view of a vehicle including a combination panel assembly, also referred to herein as a combination vehicle panel, showing the combination panel assembly (CPA) removed from the vehicle and deployed as a freestanding table at a table position distanced from the vehicle;

FIG. 2 is a schematic perspective view of the vehicle of FIG. 1, showing the combination panel assembly configured as a floor panel operable to enclose at least one vehicle compartment, the combination panel assembly positioned in the interior space of the vehicle, in an open position relative to the vehicle compartment;

FIG. 3 is a schematic perspective view of the vehicle of FIG. 1 showing the combination panel assembly in a vehicle position operable as a floor panel in the cargo area of the vehicle, and further showing the combination panel assembly fully detached from the vehicle and deployed as a freestanding table in a table position, the table position at a distance D from the vehicle;

FIG. 4 is a schematic perspective bottom view of the combination panel assembly, showing the leg system attached to an attachment side of the vehicle panel, with the leg system in a stowed position;

FIG. 5 is a schematic perspective bottom view of the combination panel assembly of FIG. 4 showing the leg system in a deployed position;

FIG. 6 is a schematic perspective top view of the combination panel assembly of FIG. 5, showing the combination panel assembly in a table position operable for use as a freestanding table, such that an appearance side of the vehicle panel defines a table surface of the freestanding table;

FIG. 7 is a schematic bottom view of a combination panel assembly showing another example configuration of the leg system, with the legs in the stowed position;

FIG. 8 is a schematic perspective top view of the combination panel assembly of FIG. 7, showing the combination panel assembly in a table position with the legs in the deployed position, such that the combination panel assembly operable as a freestanding table;

FIG. 9A is a schematic plan view of a leg including a plurality of leg segments configured as telescoping inner and outer tubular leg segments, shown in a deployed position relative to the vehicle panel and extended to an extended length (EL);

FIG. 9B is a schematic plan view of the leg of FIG. 9A, shown in a stowed position relative to the vehicle panel, with the leg segments compacted to a compacted length (CL);

FIG. 10 is a schematic top view of the vehicle panel of the combination panel assembly showing the appearance surface of the vehicle panel;

FIG. 11 is a schematic top view of the combination panel assembly of FIG. 10 including the vehicle panel and leg system;

FIG. 12 is a schematic cross-sectional view of section 12-12 of FIG. 11, showing multiple layers of the vehicle panel of FIG. 11 including a core member, the appearance surface defined by an appearance layer adhered to the core member, and the attachment side;

FIG. 13 is a schematic cross-sectional view of section 13-13 of FIG. 10, showing the combination panel assembly in the vehicle position with the vehicle panel enclosing a compartment of the vehicle;

FIG. 14A is a schematic top view of the combination panel assembly showing the example leg system of FIG. 7;

FIG. 14B is a schematic bottom view of the combination panel assembly showing the example leg system of FIG. 7;

FIG. 15 is a schematic illustration of an example method for forming the combination panel assembly of FIG. 1;

FIG. 16 is a schematic illustration of another example method for forming the combination panel assembly of FIG. 1;

FIG. 17 is a schematic perspective side view of a leg receiver including a pivot joint for attachment of the leg system of FIG. 7 to the vehicle panel;

FIG. 18 is a schematic perspective side view of the leg receiver of FIG. 17, showing a locking element for locking a leg of the leg system in a deployed position;

FIG. 19 is a photographic image of a perspective view of a combination panel assembly including a handle and a closure trim configured as a metal bezel; and

FIG. 20 is a schematic cross-sectional view of an example vehicle panel including an appearance surface defined by a laminate structure adhered to the appearance side of the core member of the vehicle panel.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure. Furthermore, the disclosure, as illustrated and described herein, may be practiced in the absence of an element that is not specifically disclosed herein.

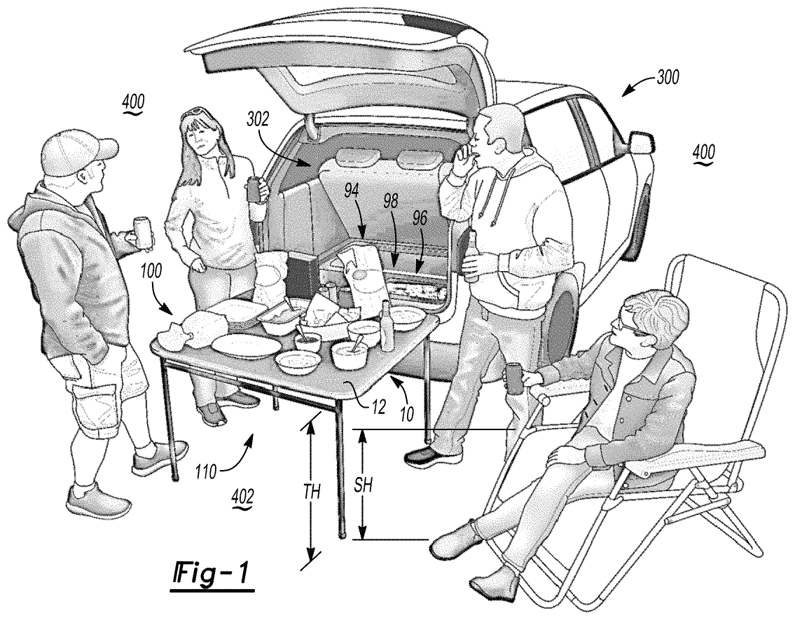

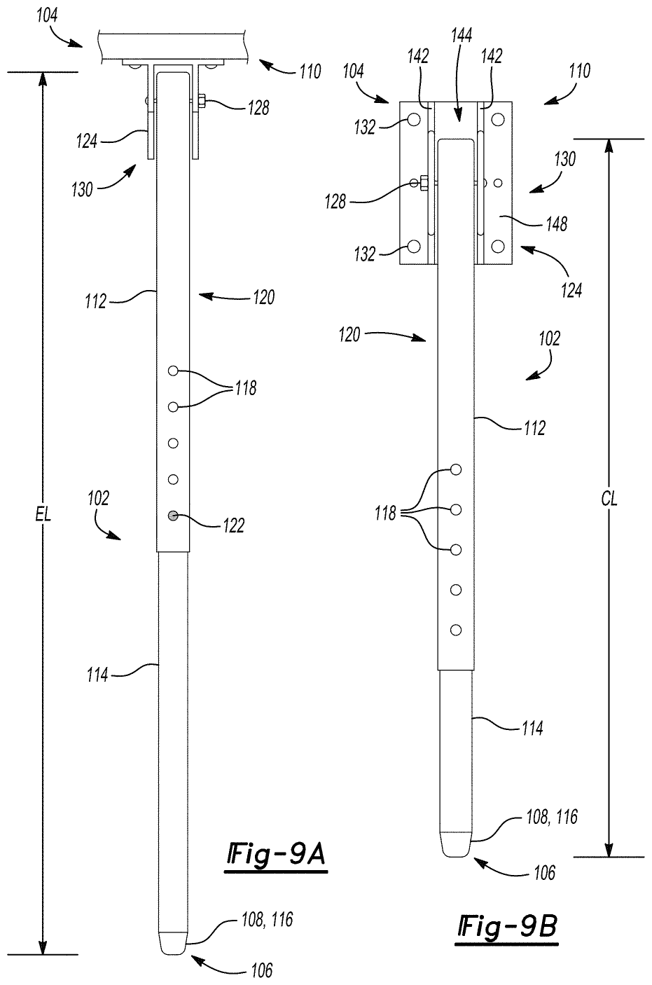

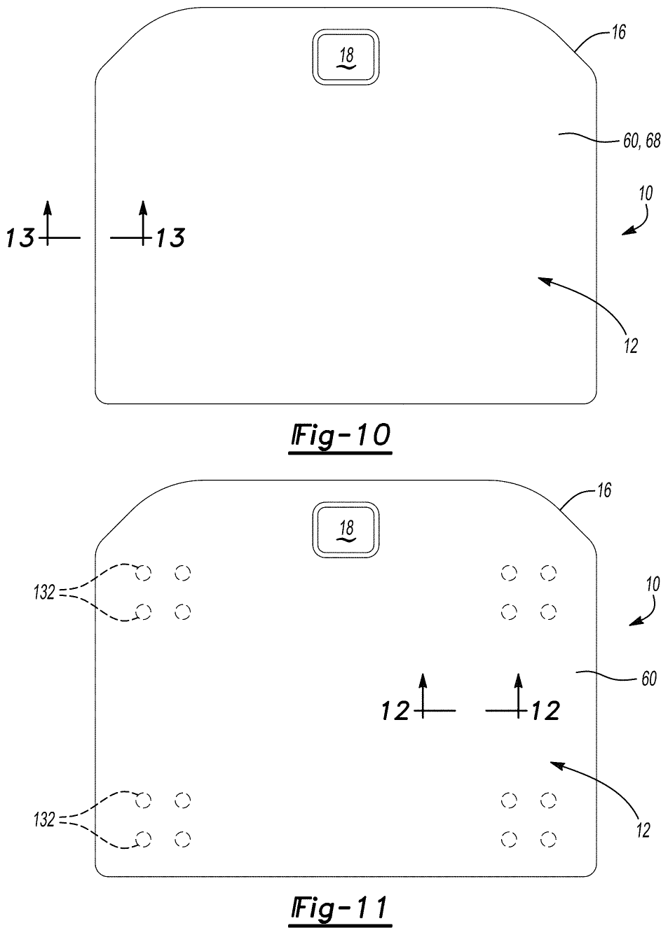

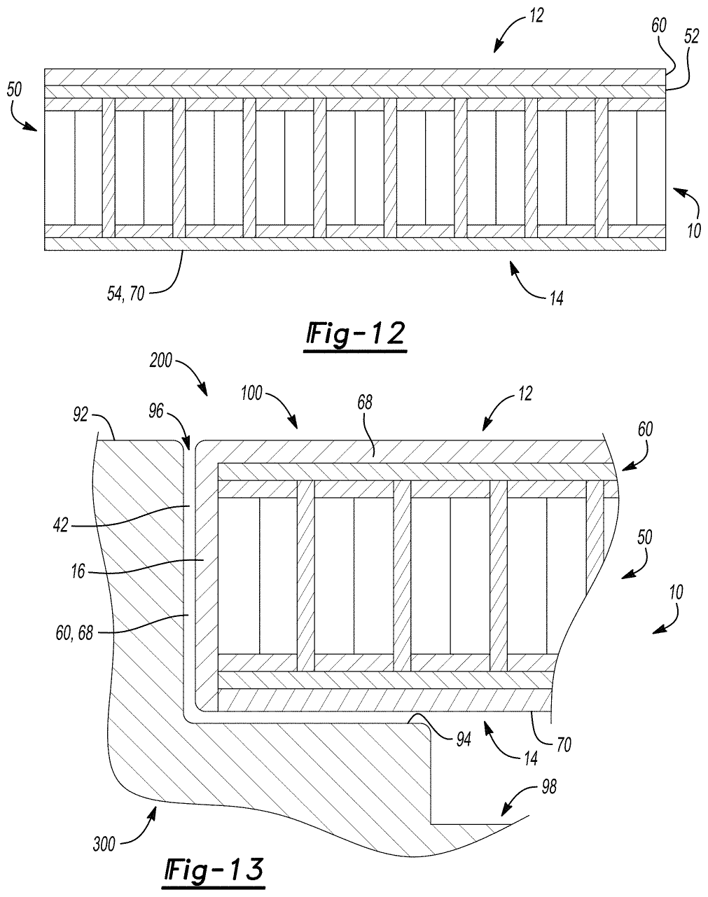

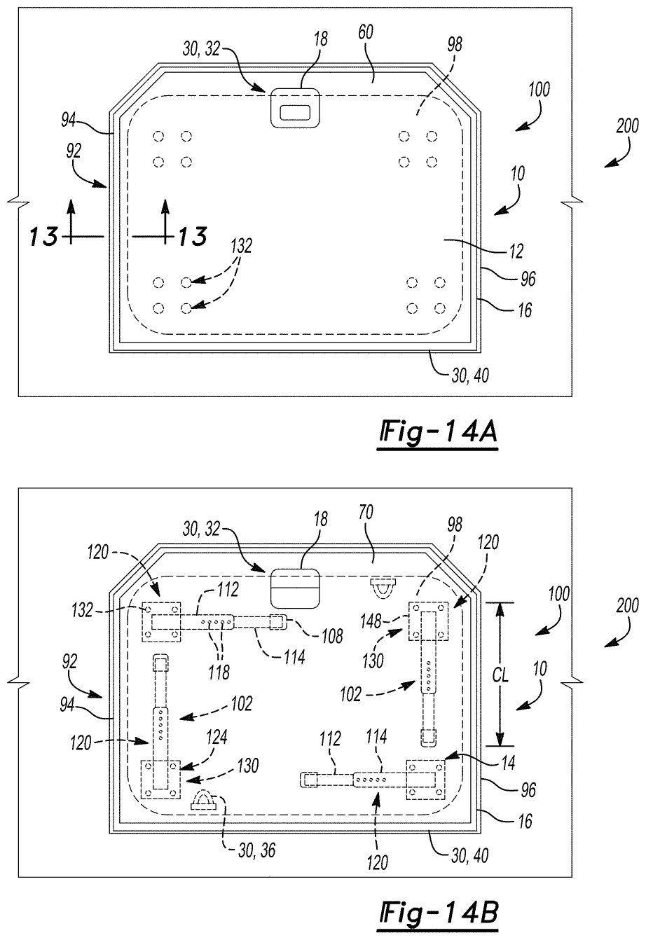

Referring to the drawings wherein like reference numbers represent like components throughout the several figures, the elements shown in FIGS. 1-20 are not necessarily to scale or proportion. Accordingly, the particular dimensions and applications provided in the drawings presented herein are not to be considered limiting. FIGS. 9A and 9B can be referred to collectively herein as FIG. 9. FIGS. 14A and 14B can be referred to collectively herein as FIG. 14.

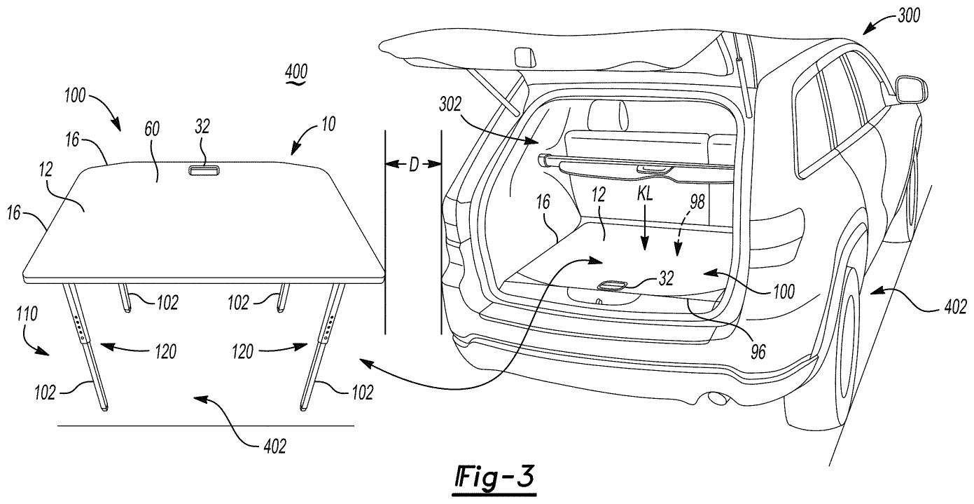

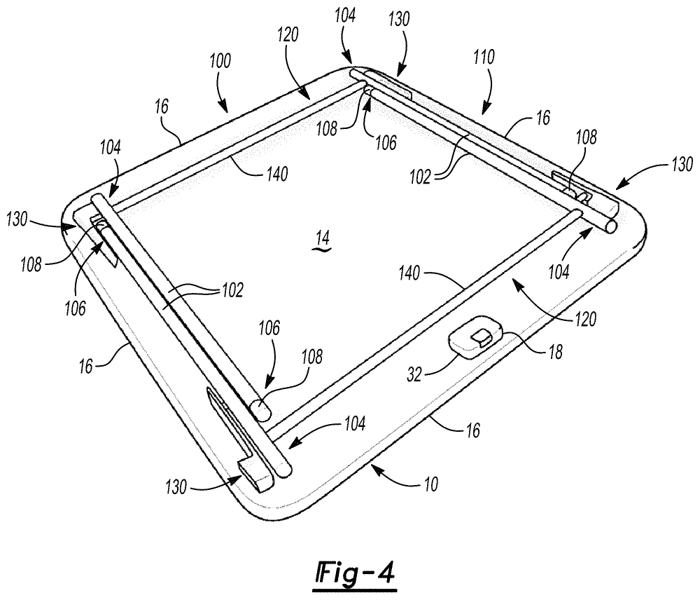

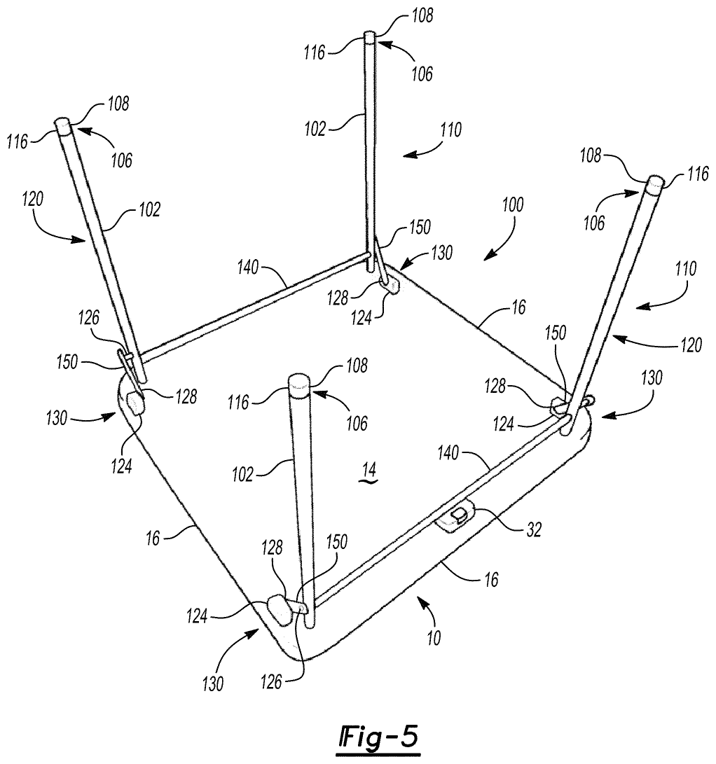

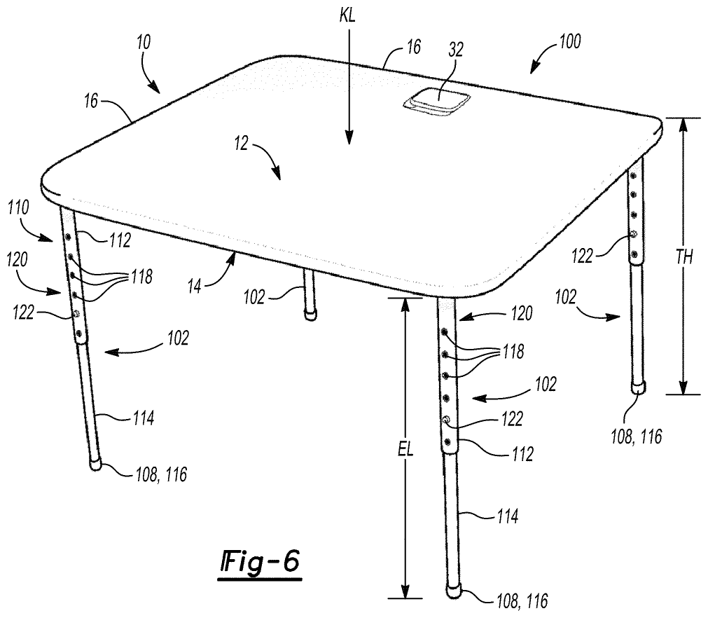

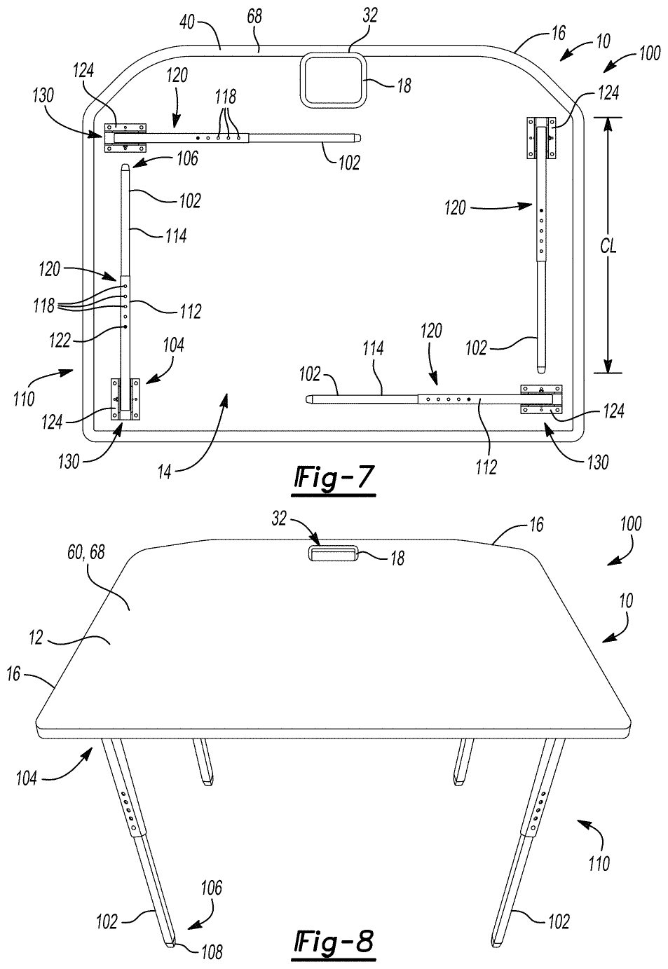

A combination panel assembly 100 including a vehicle panel 10 and a leg system 110, and example methods 230, 235 for making the vehicle panel 10 and combination panel assembly 100 are provided herein. The combination panel assembly (CPA) 100 can be referred to herein as a CPA 100, and/or as a combination vehicle panel 100. The vehicle panel 10 can be referred to herein as an enclosure panel 10. As shown in FIG. 3, the CPA 100 is moveable between a first position referred to herein as a vehicle position or a vehicle installed position, and a second position referred to herein as a table position, where in the table position, the CPA 100 is fully detached from the vehicle 300, as illustrated by a separation distance D shown in FIG. 3. In the illustrative example shown in FIGS. 1-3, the CPA 100 in a vehicle position is located within an interior space 302 of the vehicle 300, and the CPA 200 in the table position is located within an exterior space 400, e.g., exterior to and fully detached from the vehicle 300. As such, the CPA 100 is portable, and can be transported any distance D from the vehicle 300, and by deploying the leg system 110, can be used as a freestanding table, where in the table position, the vehicle panel 10 comprises the tabletop of the freestanding table, including a table surface 60 defined by an appearance surface 60 of the vehicle panel 10. In the table position, the leg assembly 110 of the CPA 100 can be in a stowed position as shown in FIGS. 4 and 7, or in a deployed position as shown in FIGS. 5, 6 and 8. In the table position, the CPA 100 with the leg assembly 110 in the stowed position provides a compact configuration for ease of transporting the CPA 100 a distance D away from the vehicle 300. In the table position with the leg assembly 110 in the deployed position, the CPA 100 functions as a freestanding table. The CPA 100 in the table position with the leg system 110 in the deployed position can be referred to herein as a freestanding table, where the term “freestanding table” as used herein, refers to the CPA 100 with the vehicle panel 10 being supported by the plurality of legs 102 in the deployed position, such that the table formed by the combination of the vehicle panel 10 and the plurality of legs 102 in the deployed position is configured to stand independently on a surface, such as a ground surface 402, without being anchored or otherwise attached to another element, without being anchored or otherwise attached to the ground surface 402, and without being anchored or otherwise attached to the vehicle 300. As such, the freestanding table formed by the combination of the vehicle panel 10 and the plurality of legs 102 can stand independently and detached at a distance D from the vehicle 300, and advantageously, the vehicle 300 and the freestanding table (CPA 100) can be moved and function independently of each other.

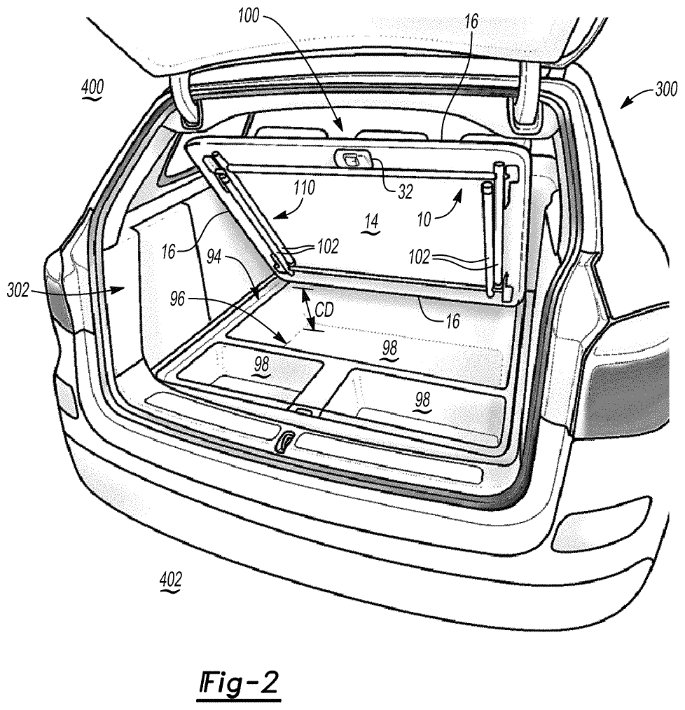

In the vehicle position, the CPA 100 is installed to a vehicle opening 96 of a vehicle compartment 98, with the vehicle panel 10 in the vehicle position enclosing the opening 96 such that the appearance surface 60 is facing outward from the compartment 98 and the leg system 110 in the stowed position is contained within the compartment 98, as shown in FIGS. 2, 3, 14A and 14B. In the non-limiting example shown in FIGS. 1-3, the vehicle compartment 98 is a floor compartment of the vehicle 300, and the vehicle panel 10 is a vehicle load bearing panel. The term “load bearing panel” as used herein, refers to a vehicle panel configured to meet the load capacity requirements specified for that vehicle panel by the vehicle manufacturer and/or industry standards for the respective vehicle panel. The term “vehicle” is not limited to the example vehicle shown in the figures, and includes automobiles, utility vehicles, trucks, vans, boats and other recreational vehicles. The terms vehicle “compartment”, “vehicle panel” and “enclosure panel” are not limited to the floor compartment and floor panel illustrated by figures, and can include other compartments and enclosure panels of a vehicle. By way of non-limiting example, a vehicle panel 10 included in a CPA 100 could be an enclosure panel enclosing a stowage compartment for a folding seat, a boat hatch lid, an access panel to access vehicle componentry such as wiring or mechanicals, etc.

The CPA 100 is advantaged as being a dual purposed assembly, being operable as both an enclosure panel 10 enclosing an opening 96 of a vehicle compartment 98, and as a freestanding table. The leg system 110 of the CPA 100, when in the stowed position, is fully contained in the vehicle compartment 98 being enclosed by the vehicle panel 10 of the CPA 100, providing the advantage of transporting a portable and deployable table in the vehicle 300 without consuming any of the interior space 302 of the vehicle 300. Further, the CPA 100 provides advantages of convenience and cost savings to the vehicle user, by having a deployable freestanding table in the vehicle 300 at all times, such that the freestanding table is available for use to the vehicle user without any advance planning and without having to load a separate (non-CPA or conventional folding) table into the interior space 302 of the vehicle 300 from another location, and without having to incur the cost of acquiring the separate conventional table. Additionally, as compared to known vehicle-mounted (non-freestanding) accessory tables such as hitch-mounted or tailgate-mounted accessory tables which must be stored when not in use, consuming cargo space of the vehicle, which must be attached to the vehicle for support, which can only be used when the vehicle is in a parked condition, and which can only be used where the vehicle is located, the CPA 100 disclosed here provides numerous advantages including the ability to fully detach the CPA 100 from the vehicle 300 and to deploy the CPA 100 as a freestanding table in any location, including a location which may be remote from the vehicle 300, such that when the CPA 100 is in use as the freestanding table, the vehicle 300 and the freestanding table are detached from each other, each performing its respective function as a vehicle 300 and freestanding table independently, including the ability to move independently of the other. As described further herein, the CPA 100 can include a lightweight core 50, such that the freestanding table is lightweight and manually portable. In an illustrative example, the leg system 110 of the CPA 100 includes a plurality of leg segments 112, 114 such that the legs 102 are advantageously adjustable between a compressed leg length CL and an extended leg length EL, such that the freestanding table can be adjusted to various tabletop heights TH for different use conditions, e.g., as a children's play table, a dining table, a work table, etc. and for use with chairs of various seat heights SH, such as beach chairs, dining chairs, bar stools, etc., and such that the legs 102 can be adjusted to the compressed leg length CL for compact storage.

The CPA 100, in a vehicle position, is installed to a vehicle portion 200 of the vehicle 300, as shown in FIGS. 1-3 and 13, such that in the vehicle position, the vehicle panel 10 of the CPA 100 encloses one or more openings 96 in the vehicle portion 200, where an opening 96 can be referred to herein as a compartment opening 96. The vehicle panel 10 can be referred to herein as a panel 10, as an enclosure panel 10, a closure panel 10, as a load bearing panel 10 and/or as a multilayer panel 10. The vehicle panel 10 include opposing first and second panel sides 12, 14. The first panel side 12 can be referred to herein as the appearance panel side 12, and includes the appearance layer 60 such that the appearance panel side 12 defines an appearance surface of the vehicle 300. The second panel side 14 can be referred to herein as the attachment panel side 14. As shown in the figures, the leg system 110 including a plurality of legs 102 and a plurality of leg receivers 130 is attached to the attachment panel side 14. The plurality of legs 102 are deployable between a stowed position as shown in FIGS. 2, 4, 7, 14B and 17, and a deployed position as shown in FIGS. 1, 5, 6, 8 and 18.

Referring to FIGS. 1, 2, 13, 14A and 14B, the opening 96 is defined by a compartment peripheral surface 92 of the vehicle portion 200 and a vehicle compartment 98. The vehicle portion 200 can include a panel interface 94 (see FIG. 13) adjacent the peripheral surface 92 and operable to support the vehicle panel 10 in the vehicle position, e.g., as installed to the opening 96 to enclose the opening 96 and the vehicle compartment 98. As shown in FIG. 2, in the vehicle position, the leg system 110 and the plurality of legs 102 are in the stowed position, such that the leg system 110 is contained within the vehicle compartment 98, as shown in FIG. 3. The vehicle portion 200 can include one or more interior compartments 98 which are accessible via the opening 96, such that when the CPA 100 is installed in the opening 96, the CPA 100 encloses the opening 96 and the interior compartment 98.

In a non-limiting example shown in the figures, the compartment peripheral surface 92 is defined by a load floor of the vehicle 300, the load floor 92 of the vehicle 300 including at least one interior compartment 98 which is accessible via an opening 96 in the load floor 92. The interior compartment 98 has a compartment depth CD and can be configured, for example, for storage of a spare tire for the vehicle 300, luggage, a stowed seat of the vehicle 300, etc. The vehicle panel 10 of the CPA 100 is configured to enclose the opening 96 in the vehicle load floor 92 when the vehicle panel 10 is installed in the opening 96 with the leg system 110 in a stowed position, as further described herein and shown in FIG. 2. In the example shown in FIGS. 2, 3, 13 and 14, the vehicle panel 10 includes a contoured perimeter edge 16 which is configured to correspond to the opening 96 such that with the CPA 100 in the vehicle position, the contoured perimeter edge 16 is adjacent the compartment periphery surface 92 and supported in the opening 96 by the panel interface 94.

In an illustrative example, the vehicle panel 10 has opposing appearance and attachment sides 12, 14. The appearance side 12 includes an appearance outer layer 60 which can be made of a textile material, a carpeting material 68, a protective polymeric coating 70 such as a thermosetting polyurethane-based coating or a polyvinyl-based material, a thermoset polyurea coating, or a laminate structure 80 which can, in an illustrative example, include a wood veneer. The appearance outer layer 60, in one example, can include one or more decorative elements 78 including, by way of non-limiting example, a decal, embossment, etching, etc. which is applied to the appearance layer 60. By way of example, the decorative element 78 can be in the form and/or shape of a pattern, image, logo, etc. applied to, molded in, and/or integral to the appearance layer 60.

In one example, the vehicle panel 10 is formed as a multilayer panel including a compression molded core member 50 interposed between the appearance outer layer 60 forming the appearance side 12 of the vehicle panel 10, and the attachment outer layer 70 forming the attachment side 14 of the vehicle panel 10. In one example, the vehicle panel 10 is a load bearing panel including a core member 50 configured as a load bearing member such that the multilayer vehicle panel 10 can withstand a minimum knee loading requirement. In one example, the vehicle panel 10 is a load bearing panel having a load capacity such that deflection of the vehicle panel in the direction a minimum knee load (KL) of at least 250 pounds is applied as a point load to a central portion of the vehicle panel 10 (see FIGS. 3 and 6) does not exceed 25 mm during loading, and/or such that the permanent deflection of the vehicle panel 10 after loading to 250 pounds knee load does not exceed 10 mm. In one example, the vehicle panel 10 is a vehicle floor panel configured to withstand bending and deflection forces and loads imposed by items which may be place on the floor panel, which may include vehicle users standing, sitting or kneeling on the floor panel 10, or items placed on the exposed surface of the floor panel 10, which can include personal items of the vehicle user such as luggage, sporting goods, groceries, furniture, etc., and can further include industrial items such as tools and equipment, wherein in an illustrative example, the vehicle panel 10 has a distributed load capacity of 400 pounds or greater.

In an illustrative example, the core layer 50 can be made of a cellular material which provides the load bearing strength using a lightweight material, such that the combination panel assembly 100 including the lightweight core member 50 is readily transportable as a portable freestanding table to a location which may be distanced from the vehicle 300. In an illustrative example, the vehicle panel 10 is a multilayer panel configured as disclosed in U.S. patent application Ser. No. 15/943026, published as U.S. Publication No. 2018/0290418 A1, which is incorporated herein by reference. In one example, the combination vehicle panel 100, including the vehicle panel 10 and leg system 110, has a total weight of less than 20 pounds, such that the combination vehicle panel is easily removed from the vehicle 300 and manually transported a distance from the vehicle 300. In one example, the combination vehicle panel 100 has a total weight of less than 15 pounds. In a preferred example, the combination vehicle panel 100 has a total weight of less than 12 pounds. The example of a multilayer panel as described in U.S. Publication No. 2018/0290418 A1 is non-limiting, and other configurations of lightweight vehicle panels 10, including, for examples, vehicle panels 10 comprising a core made of a foam material or a cellular material, molded panels made of a polymeric material, laminate panels, or panels made of other lightweight materials, including metal and/or organic materials such as wood or wood composites, can be included in the CPA 100 described herein.

The vehicle panel 10 can include one or more trim elements 30 attached thereto, including, for example, a closure trim element 40, such as a bezel element 42, can be included to enclose and/or encapsulate the perimeter edge 16 of the vehicle panel 10, to provide a decorative and/or functional table edge of the tabletop of the freestanding table. In one example, a sealant layer 28 can be applied to the appearance layer 60, and a decorative element 78 such as a decal, painted element, etc. can be positioned between the appearance layer 60 and sealant layer 28. The CPA 100 and/or the vehicle panel 10 can include a handle opening 18 and/or a handle 32 for removing the combination panel assembly 100 from the vehicle 300 and/or for conveniently carrying the combination panel assembly 100 to a location distant from the vehicle 300.

In an illustrative example, the vehicle panel 10 can be configured as a multilayer panel including a core member 50 and a cover layer 52, wherein the cover layer 52 can be configured as an appearance layer 60 defining an appearance surface of the vehicle panel 10. The appearance layer 60 defines an appearance surface of the vehicle 300, where the appearance surface is visible a vehicle user. In a non-limiting example, the appearance layer 60 can be made of a carpet material 68, suitable for use as a floor covering of the floor panel 10 and for use as a table surface. In another example, the appearance layer 60 can be a laminate material 80, such as a wood or metal laminate, which may be coated with a protective coating 28, to provide a decorative appearance surface protected for use in vehicle panel and table surface applications. In another example, the appearance layer 60 can be made of a polyurea material to provide an appearance surface which is resistive to abrasion and chemical attack and suitable for use as a work surface in the vehicle 300 and/or as a table surface. When the CPA 100 is deployed as a freestanding table, as shown in FIGS. 1, 6 and 8, for example, the vehicle panel 10 functions as a tabletop of the freestanding table, and the appearance side 12 including the appearance layer 60 defines the top surface of the tabletop, also referred to herein as a table surface.

The first side 12 of the vehicle panel 10, also referred to as the appearance side, can includes an appearance layer 60 made of one of a laminate material, a textile material 68, or a polymer coating material such that the first side 12 can be decorative and/or configured to coordinate with and/or correspond with other appearance materials forming appearance surfaces of the vehicle. In the example shown in FIGS. 3 and 8, the first appearance layer 60 is made of a textile material 68, which in non-limiting examples can be a carpet material, an organic material such as leather, a scrim material, or other textile material. In one example, a polymer coating material 28, 70 such as a polyurethane-based or polyurea material can be applied to the appearance and/or the attachment sides 12, 14 of the vehicle panel 10 to provide a surface which is resistant to abrasion, scratching, chipping, denting, impact, staining, chemical attack and ultraviolet exposure, etc. when the CPA 100 is deployed as a freestanding table.

The second side 14 of the vehicle panel 10 defines the attachment surface to which the leg system 110 is attached, and can be made of a scrim material, or other textile material. In one example, the second side 14 of the vehicle panel 10 can include a cover layer 54 which can be configured as an appearance layer 70.

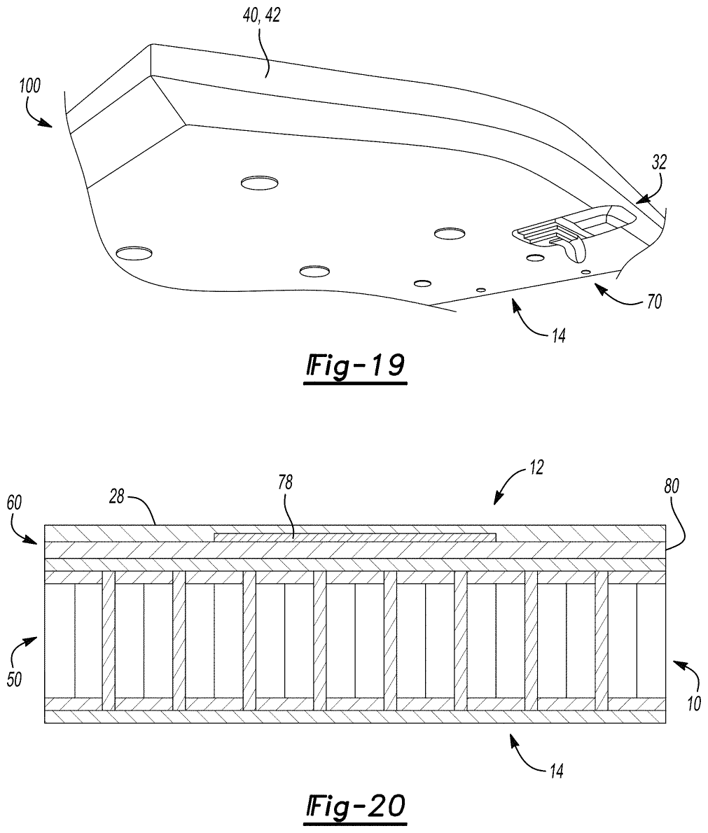

The CPA 100 and/or the vehicle panel 10 can include one or more trim elements 30. In a non-limiting example shown in FIGS. 1 and 2, trim elements 30 can include a handle 32, hold down attachments 36, and closure trim 40. In the illustrative example, the handle 32 is a two-sided handle fitted into an aperture 18 formed in the vehicle panel 10 such that the handle 32 is accessible from each of the first and second sides 12, 14 by a user, for ease of moving the combination panel assembly 100 into and out of the vehicle opening 96, for example, when removing the CPA 100 from the vehicle 300 for deployment as a freestanding table, or when repositioning the CPA 100 in a stowed position in the opening 96, to enclose the vehicle compartment 98 as a floor panel of the vehicle. The closure trim 40 in the example shown in FIG. 19 is formed as a metal bezel 42 which encapsulates the perimeter edge 16 of the vehicle panel 10, for decorative appearance and as a protective edge for the tabletop when the CPA 100 is deployed as a freestanding table. The panel 10 can include one or more extensions or tabs 26, as shown in FIG. 8, which can correspond to recesses in the opening 96 or vehicle floor 92 to facilitate orientation and/or retention of the combination panel assembly 100 in the opening 96.

The vehicle panel 10 can be configured as a load bearing vehicle panel, including, for example, a multilayer structure configured such that the vehicle panel 10 has a load bearing capacity to withstand a minimum knee loading requirement and/or support a minimum load distribution. In one example, the vehicle panel 10 is a load bearing panel having a load capacity such that deflection of the vehicle panel in the direction a minimum knee load (KL) of at least 250 pounds is applied as a point load to a central portion of the vehicle panel is applied does not exceed 25 mm during loading, preferably does not exceed 15 mm during loading, more preferably, does not exceed 10 mm during loading. In one example, the vehicle panel 10 has a load capacity such that the permanent deflection of the vehicle panel after loading to 250 pounds knee load does not exceed 10 mm, and in an illustrative example, does not exceed 5 mm. In one example, the vehicle panel 10 is a vehicle floor panel 10 configured to withstand bending and deflection forces and loads imposed by items which may be place on the floor panel 10, which may include vehicle users standing, sitting or kneeling on the floor panel 10, or items placed on the exposed surface of the floor panel 10, which can include personal items of the vehicle user such as luggage, sporting goods, groceries, furniture, etc., and can further include industrial items such as tools and equipment, wherein in an illustrative example, the vehicle panel 10 has a distributed load capacity of 400 pounds or greater.

As shown in the figures, the CPA 100 includes a leg system 110 including a plurality of legs 102, which are operable, in a deployed position as shown in FIGS. 1, 6 and 8, to support the vehicle panel 10 at a table height TH, to provide a freestanding table. The leg system 110 is attached to the vehicle panel 10 via a plurality of leg receivers 130 which are attached to the attachment side 14 of the vehicle panel 10. The leg system 110 and leg receivers 130 are configured such that the legs 102 are selectively moveable relative to the vehicle panel 10, between a stowed position as shown in FIGS. 2, 4, 7, 14B and 17, and a deployed position as shown in FIGS. 1, 5, 6, 8 and 19. The leg system 110 includes a plurality of leg assemblies 120, each leg assembly 120 including at least one leg 102 and at least one leg 130. The examples shown in the figures are non-limiting, and it would be understood that multiple legs 102 can be attached to the vehicle panel 10 by a single leg receiver 130, for example, in an arrangement where a pair of legs 102 are connected by an intermediate element to form a U-shape, and the intermediate element is connected to a singular leg receiver 130 to form a leg assembly 120.

As illustrated by the figures, the leg receivers 130 can be attached to the vehicle panel 10 by fasteners 132, which can be, for example, screws, rivets, studs, clips, pins, etc. The example is non-limiting, such that the leg receivers 130 can be attached by any means suitable to retain the leg receivers 130 to the vehicle panel 10, including adhesives, welding including plastic welding, etc. In an illustrative example shown in FIGS. 2, 4 and 5, the leg system 110 can include one or more stabilizing elements 140, which can be configured to increase the rigidity and/or stability of the CPA 100 when deployed as a freestanding table.

As shown in FIGS. 4-9B, the leg 102 includes a first end which defines a leg connection interface 104 for connecting the leg 102 to the leg receiver 130, and a second end 106 which can be referred to as a foot end 106. The foot end 106 includes a foot 108, upon which the freestanding table rests when in an upright table position. In a non-limiting example, the foot end 108 can include a tip attachment 116 operatively attached to the foot end 108. The tip attachment 116 can be configured as a cup, spike, bale, quad foot, or other configuration, to seal, protect, stabilize or modify the foot end 108 for a particular use of the freestanding table.

In an illustrative example shown in FIGS. 6-8, 9A and 9B, the leg 102 is configured to be adjustable in length to a compressed length CL, an extended length EL, and/or an intermediate length greater than the compressed length CL and less than the extended length EL, such that in the table position, the tabletop height TH (see FIG. 1) can be adjusted by adjusting the length of the legs 102 to a height suitable for the use of the freestanding table, and/or suitable to the seat height SH of seating being used with the freestanding table, as previously described herein. In a non-limiting example, the adjustable leg 102 includes a plurality of leg segments including at least first and second leg segments 112, 114, selectively attachable to each other and moveable relative to each other to adjust the length of the leg 102. In the example shown, the leg segments 112, 114 are configured as outer and inner tubular members, where the inner leg segment 114 is moveable relative to the outer leg segment 112 to adjust the length of the leg 102. In the example shown, the outer leg segment 112 includes a plurality of button apertures 118 to receive a detent or retractable button connector 122, to adjust the leg 102 to a selected length. The example is non-limiting, such that the leg 102 can include other arrangements of a plurality of leg segments 112, 114, etc. to provide a leg 102 which is adjustable in length, including, for example, telescoping leg segments, spring-loaded leg segments, etc.

As illustrated in the figures, the leg 102 is operatively connected to the leg receiver 130 by a connection between the leg connection interface 104 of the leg 102 and a receiver connection interface 124 defined by the leg receiver 130. In a non-limiting example shown in FIGS. 4 and 5, the leg receiver 130 includes a receiver connection interface 124 including a pivot joint 128 and connecting brace 150, also referred to as a hinge brace 150, such that the leg 102 is movable by the pivot joint 128 and connecting brace 150 between a stowed position shown in FIG. 4 and a deployed position shown in FIG. 5. In the example shown, the leg assembly 120 includes a locking element 126 operable to selectively lock the hinged joint between the leg 102 and the leg receiver 130 in the deployed position, and to selectively unlock the hinged joint, to release the leg 102 when returning the leg 102 to the stowed position.

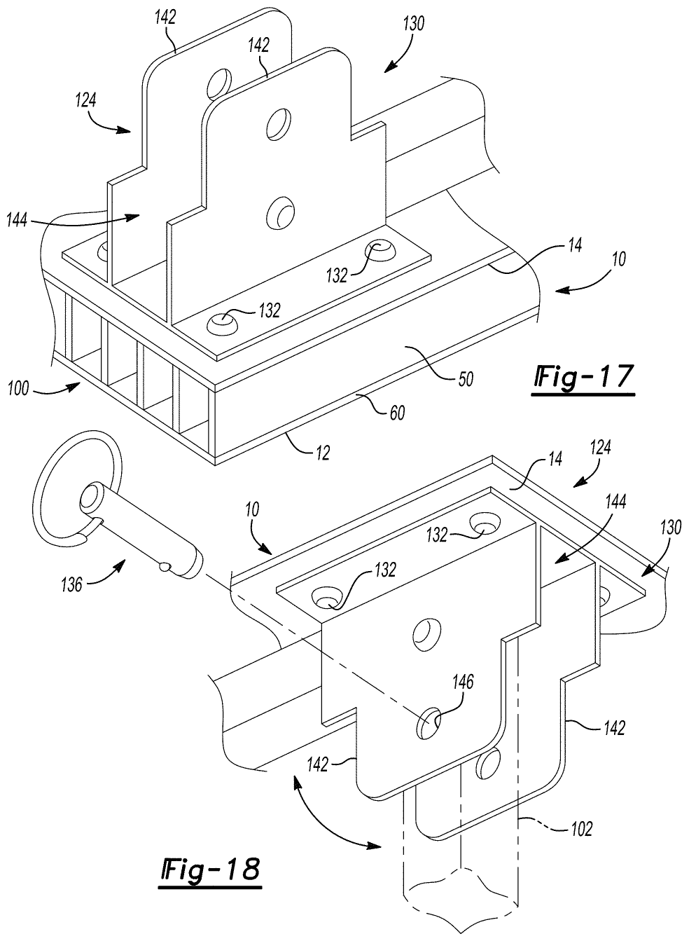

In a non-limiting example shown in FIGS. 7, 8, 9A, 9B, 17 and 18, the leg receiver 130 includes a receiver connection interface 124, including a pivot joint 128 and locking element 136, also referred to as a locking pin or plunger pin, such that the leg 102 is hingedly movable by the pivot joint 128 between a stowed position shown in FIGS. 7, 9B and 17 and a deployed position shown in FIGS. 8, 9A and 18, lockable in the deployed position by insertion of the locking element 136 into a pin aperture 146 as shown in FIG. 18. In the stowed position shown in FIG. 17, the locking pin 136 can be inserted into the pin aperture 146, to retain the leg 102 in the stowed position by impeding pivoting of the leg 102 in the bracket channel 144 defined by bracket arms 142. In the example shown, the leg receiver 130 includes flanges 148 for attaching the leg receiver 130 to the attachment side 14 of the vehicle panel 10, using fasteners 132.

In a non-limiting example, one or more leg retainers can be included in the CPA 100, to retain legs 102 to the attachment side 14 of the vehicle panel 10 in the stowed position, for example, where the legs 102 are selectively detachable from the leg receivers 130, via a threaded connection, detent connection, press fit connection, locking pin connection, spring plunger connection, retractable button connection, or similar connection interface from which the leg 102 is selectively detachable from the leg receiver 130 in the stowed position. In an illustrative example, the leg retainer can be operatively attached to or integral to the vehicle panel 10, configured as a clip, slot, groove, magnetic attachment, loop, elastic attachment, net, pocket, sleeve or other type retainer, by which the detached leg 102 can be retained to the vehicle panel 10 in the stowed position during transport of the CPA 100 and/or when the CPA 100 is in the vehicle position, such that the legs 102 retained by the leg retainer to the attachment side 14 of the vehicle panel 10 are contained in the vehicle compartment 98 when the CPA 100 is in the vehicle position.

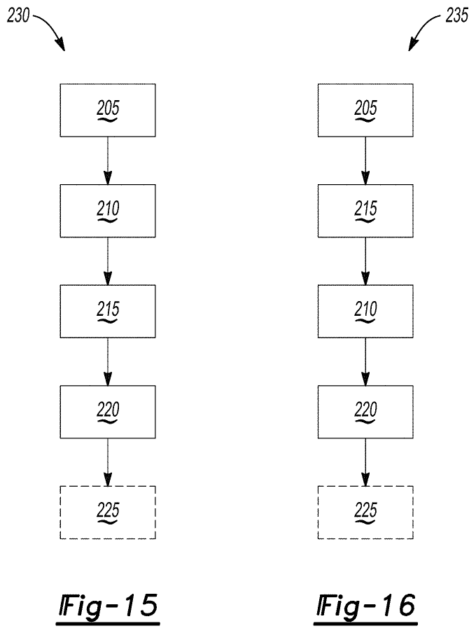

Referring now to FIGS. 15 and 16, example methods 230, 235 of making the CPA 100 are illustrated. Referring to FIG. 15, an illustrative method 230 includes, at step 205, forming the vehicle panel 10, for example, by compression molding, where the vehicle panel 10 can be formed as a multilayer panel as described herein. At step 210, fasteners 132 are installed to the vehicle panel 10 for fastening leg receivers 130 to the attachment side of the vehicle panel 10. At step 215, an appearance layer 60 is applied to the appearance side 12 of the vehicle panel 10. At step 220, the leg system 110 including legs 102 is attached to the leg receivers 130. At optional step 225, trim components can be assembled to the vehicle panel 10 and/or legs 102 to complete assembly of the CPA 100. In another example shown in FIG. 16, the order of steps 210 and 215 can be reversed. The examples shown in FIGS. 15 and 16 are non-limiting, and it would be understood that other methods and ordering of steps can be used to form a CPA 100 as described herein.

As used herein, the terms “a,” “an,” “the,” “at least one,” and “one or more” are interchangeable and indicate that at least one of an item is present. A plurality of such items may be present unless the context clearly indicates otherwise. All numerical values of parameters, quantities, or conditions in this disclosure, including the appended claims, are to be understood as being modified in all instances by the term “about” or “approximately” whether or not “about” or “approximately” actually appears before the numerical value. “About” and “approximately” indicate that the stated numerical value allows some slight imprecision (e.g., with some approach to exactness in the value; reasonably close to the value; nearly; essentially). If the imprecision provided by “about” or “approximately” is not otherwise understood with this meaning, then “about” and “approximately” as used herein indicate at least variations that may arise from methods of measuring and using such parameters. Further, the terminology “substantially” also refers to a slight imprecision of a condition (e.g., with some approach to exactness of the condition; approximately or reasonably close to the condition; nearly; essentially). In addition, disclosed numerical ranges include disclosure of all values and further divided ranges within the entire disclosed range. Each value within a range and the endpoints of a range are all disclosed as separate embodiments. The terms “comprising,” “includes,” “including,” “has,” and “having” are inclusive and therefore specify the presence of stated items, but do not preclude the presence of other items. As used in this disclosure, the term “or” includes any and all combinations of one or more of the listed items.

The above features and other features and advantages of the present invention are readily apparent from the detailed description of the best modes for carrying out the invention described herein, when taken in connection with the accompanying drawings. While some of the best modes and other embodiments for carrying out the claimed invention have been described in detail, various alternative designs and embodiments exist for practicing the invention.

1. A combination panel assembly, the combination panel assembly comprising:
a vehicle panel including opposing first and second panel sides;
a vehicle appearance surface defined by the first panel side;
a leg system attached to the second panel side;
the leg system including a plurality of legs;
the plurality of legs movable between a stowed position and a deployed position;
the vehicle panel movable between a vehicle position and a table position;
wherein when the vehicle panel is in the vehicle position and the plurality of legs is in the stowed position, the vehicle panel encloses a compartment opening defined by a vehicle compartment of a vehicle; and
wherein when the vehicle panel is in the table position and the plurality of legs is in the deployed position, the vehicle panel and leg system comprise a freestanding table.

2. The combination panel assembly of claim 1, wherein:
when the vehicle panel is in the vehicle position, the vehicle appearance surface defines an interior surface of the vehicle; and
when the vehicle panel is in the table position, the vehicle appearance surface defines a table surface of the freestanding table.

3. The combination panel assembly of claim 1, wherein the vehicle appearance surface is made of a carpet material.

4. The combination panel assembly of claim 1, further comprising:
the vehicle panel including:
a core member; and
an appearance layer adhered to the core member and defining the vehicle appearance surface;
wherein the appearance layer includes at least one of:
a laminate material;
a textile material; or
a polyurea material.

5. The combination panel assembly of claim 1, wherein when the vehicle is in the table position the vehicle panel including the leg system is fully detached from the vehicle.

6. The combination panel assembly of claim 1, wherein:
the vehicle panel is configured as a vehicle floor panel; and
the vehicle appearance surface defines a vehicle floor surface.

7. The combination panel assembly of claim 1, wherein when the vehicle panel is in the vehicle position, the vehicle panel is operable as a load bearing vehicle panel.

8. The combination panel assembly of claim 1, further comprising:
at least one locking element operable to lock a leg of the plurality of legs in the deployed position.

9. The combination panel assembly of claim 1, further comprising:
the leg system including a plurality of leg receivers;
the plurality of leg receivers attached to the second panel side;
the plurality of leg receivers operable to attach the plurality of legs to the vehicle panel;
wherein when the plurality of legs is in the deployed position, the plurality of legs is operatively attached to the plurality of leg receivers.

10. The combination panel assembly of claim 9, further comprising:
the leg system including a plurality of pivot joints operable to pivot the plurality of legs between the stowed position and the deployed position.

11. The combination panel assembly of claim 9, further comprising:
the leg system including a plurality of hinged joints operable to move the plurality of legs between the stowed position and the deployed position.

12. The combination panel assembly of claim 9, further comprising:
a leg connection interface defined by a leg of the plurality of legs;
a receiver connection interface defined by a leg receiver of the plurality of leg receivers;
wherein the leg is selectively attached to the leg receiver by a connection of the leg connection interface and the receiver connection interface.

13. The combination panel assembly of claim 12, wherein the connection of the leg connection interface and the receiver connection interface is at least one of a threaded connection, a press fit connection, a locking pin connection, a detent connection, a spring plunger connection, or a retractable button connection.

14. The combination panel assembly of claim 1, further comprising:
a leg of the plurality of legs adjustable in length between a compressed length and an extended length.

15. The combination panel assembly of claim 14, further comprising:
the leg including a plurality of leg segments;
wherein a leg segment of the plurality of leg segments is moveable relative to another leg segment of the plurality of leg segments between the compressed length and the extended length.

16. A vehicle comprising:
a vehicle compartment defining a compartment opening;
a combination panel assembly comprising:
a vehicle panel including opposing first and second panel sides;
a vehicle appearance surface defined by the first panel side;
a leg system attached to the second panel side;
the leg system including a plurality of legs;
the leg system is deployable between a stowed position and a deployed position;
wherein when the combination panel assembly is in a vehicle position and the plurality of leg system is in the stowed position, the combination panel assembly encloses the compartment opening.

17. The vehicle of claim 16, further comprising:
the combination panel assembly movable between the vehicle position and a table position;
wherein when the combination panel assembly is in the table position, the combination panel assembly is full detached from the vehicle; and
wherein when the combination panel assembly is in the table position and the leg system is in the deployed position:
the plurality of legs supports the vehicle panel at a table height; and
the combination panel assembly is operable as a freestanding table including a table surface defined by the vehicle appearance surface.

18. The vehicle of claim 16, wherein when the combination panel assembly is in the vehicle position the leg system is contained within the vehicle compartment.

19. A freestanding table comprising:
a vehicle panel including opposing first and second panel sides;
a vehicle appearance surface defined by the first panel side;
a table surface defined by the vehicle appearance surface;
a leg system attached to the second panel side;
the leg system including a plurality of legs movable between a stowed position and a deployed position;
wherein when the plurality of legs is in the deployed position:
the leg system supports the vehicle panel at a table height; and
the vehicle appearance surface is operable as a table surface.

20. The freestanding table of claim 19, where in vehicle panel is a load bearing panel having a weight load capacity of at least one of:
a distributed load capacity of at least 400 pounds; or
a knee load capacity defined by a deflection of less than 25 mm in a direction of loading during application of a knee load of 250 pounds to a central portion of the vehicle panel.
